(19) United States
(12) Patent Application Publication
(10) Pub. No.: US 2025/0239842 A1
(43) Pub. Date: Jul. 24, 2025

(54) GANGABLE ELECTRICAL BOXES AND ADJUSTABLE MOUNTING BRACKET

(71) Applicant: Hubbell Incorporated, Shelton, CT (US)

(72) Inventors: Krzysztof W. Korcz, Granger, IN (US); Victor Beristany, South Bend, IN (US); Krishna Patel, Granger, IN (US)

(21) Appl. No.: 19/028,939

(22) Filed: Jan. 17, 2025

Related U.S. Application Data
(60) Provisional application No. 63/622,846, filed on Jan. 19, 2024.

(51) Int. Cl. H02G 3/08; H02G 3/12

(52) U.S. Cl. CPC H02G 3/081; H02G 3/12

(57) ABSTRACT

An electrical box assembly includes a plurality of side walls. At least one of the plurality of side walls has a knockout configured to be removed to receive an electrical conductor. An end wall is releasably connected to the plurality of side walls. The end wall has a groove. A mounting bracket is connected to the end wall. The mounting bracket includes a mounting plate, an adjustment plate, and a threaded adjustment member received in the groove. Rotation of the adjustment member causes the mounting bracket to translate relative to the end wall.

### RELATED APPLICATION(S)

This application is based on U.S. Provisional Application Ser. No. 63/622,846, filed Jan. 19, 2024, the disclosure of which is incorporated herein by reference in its entirety and to which priority is claimed.

### FIELD

Various exemplary embodiments relate to electrical boxes and mounting brackets therefore.

### BACKGROUND

Electrical boxes are required in many situations for supporting electrical wiring devices such as receptacles, switches and connectors. Many electrical boxes have removable end walls so that two or more electrical boxes can be ganged together.

Electrical boxes having supports for electrical boxes are often used for mounting the electrical box to a support such as a wall stud. Various support devices are also used that extend from the electrical box to contact an opposing wall to support one side of the electrical box. Many of the mounting brackets are designed to be mounted to a single wall stud for supporting a single electrical box.

### SUMMARY

In certain configurations, an electrical box assembly includes a plurality of side walls. At least one of the plurality of side walls has a knockout configured to be removed to receive an electrical conductor. An end wall is releasably connected to the plurality of side walls. The end wall has a groove. A mounting bracket is connected to the end wall. The mounting bracket includes a mounting plate, an adjustment plate, and a threaded adjustment member received in the groove. Rotation of the adjustment member causes the mounting bracket to translate relative to the end wall.

In certain configurations, an electrical box assembly includes a plurality of first side walls. At least one of the first side walls having a knockout configured to be removed to receive an electrical conductor. A plurality of second side walls are positioned opposite the first side walls to define an interior for receiving an electrical device. An end wall is releasably connected to at least one of the first side walls and the second side walls. The end wall has a groove. A mounting bracket is connected to the end wall. The mounting bracket includes a mounting plate, an adjustment plate, and a threaded adjustment member received in the groove. Rotation of the adjustment member causes the mounting bracket to translate relative to the end wall.

In certain configurations, an electrical box assembly includes a plurality of first side walls. At least one of the first side walls having a knockout configured to be removed to receive an electrical conductor. A plurality of second side walls are positioned opposite the first side walls to define an interior for receiving an electrical device. An end wall is releasably connected to at least one of the first side walls and one of the second side walls. The end wall has a groove, a first connecting feature for securing the end wall to the at least one first side wall, and a second connecting feature for securing the end wall to the at least one second side wall. A mounting bracket is connected to the end wall. The mounting bracket includes a mounting plate, an adjustment plate, and a threaded adjustment member received in the groove. Rotation of the adjustment member causes the mounting bracket to translate relative to the end wall.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of an electrical box connected to a mounting brace.

FIG. 2 is a perspective view of the electrical box and mounting bracket of FIG. 1.

FIG. 3 is a side view of the electrical box showing the adjustable mounting depths.

FIG. 4 is an interior perspective view of an end wall.

FIG. 5 is an exterior perspective view of the end wall.

FIG. 6 is a partial, enlarged view of the bracket tab of the end wall.

FIG. 7 is a perspective view of a jackscrew.

FIG. 8 is a perspective view of the mounting plate and adjustment plate.

FIG. 9 is a perspective view of another electrical box and mounting bracket.

FIG. 10 is an interior perspective view of an end wall of FIG. 9.

FIG. 11 is an exterior perspective view of the end wall of FIG. 9.

FIG. 12 is a partial, enlarged view of a first connection between the end wall and side wall.

FIG. 13 is a partial, enlarged view of a second connection between the end wall and side wall.

FIG. 14 is a perspective view of the mounting plate and adjustment plate of FIG. 9.

### DETAILED DESCRIPTION OF EXEMPLARY EMBODIMENTS

Electrical devices such as, but not limited to, electrical outlets, switches, buttons, communication ports, and others, are typically installed in a wall or ceiling. In indoor applications, an electrical box, also referred to as a gang or junction box, is secured to a stud or support beam inside of the wall or ceiling. After the box is mounted, an electrical device is secured in the box in electrical communication with one or more electrical conductors. In this manner, any exposed portion of the electrical conductor and its connection to the electrical device can be shielded within the box.

In certain implementations, electrical boxes can be configured with common housing components to form gangable enclosures of different sizes. For example, any combination of single gang, double gang, or triple gang boxes can be connected together to form a required size electrical enclosure. Dividers can be used to separate different compartments as needed.

Although electrical boxes are typically connected directly to a wall stud, they can also be mounted between studs using one or more stud mounting braces. The brace can extend between traditional wall studs and have a plurality of mounting holes for connecting one or more electrical boxes at a desired location between the studs.

In certain configurations, the electrical boxes can include a plurality of side walls and removable end walls. Mounting brackets are connected to the end walls to adjustably position the electrical boxes relative to a support surface. The mounting brackets can include threaded adjustment members, where the bracket is configured so that rotation of the adjustment member causes translation of one or more components of the mounting brackets relative to a support surface.

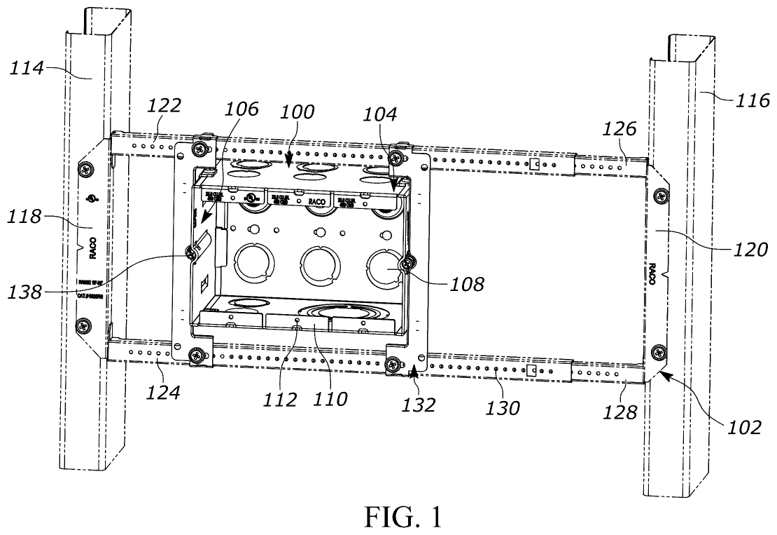

FIG. 1, shows an exemplary configuration of a three-gang electrical box connected 100 to a mounting brace 102. The illustrated electrical box 100 is configured as a switch box, with each gang configured to receive a toggle or rocker switch. The electrical box 100 includes side walls 104 (top, bottom, and rear) and removable end walls 106. Although a three-gang box 100 is shown, the box 100 is gangable and in certain configurations can be connected to other one, two, or three gang boxes to expand the number of available connections provided in a single box. Other implementations can utilize any combination of one, two, or three gang housing side wall configurations to create any size electrical box. Additionally, while only a single electrical box 100 is connected to the mounting brace 102 other electrical boxes of different sizes can be connected to the brace to provide different connection points.

The side walls 104 include a plurality of knockouts 108 positioned to provide electrical connections to the box 100. The knockouts 108 can include concentric and non-concentric circles to provide an opening as large as four inches as needed. The knockouts 108 can be removed as needed to provide communication with exterior cabling or conduits that are run to the box 100.

The upper and lower side wall 104 can include inwardly extending flanges 110 for supporting an electrical wiring device, for example a switch. Each flange 110 includes a threaded aperture 112 for receiving a mounting screw. Each flange 110 is spaced apart to form a slot for receiving a divider plate.

The mounting brace 102 extends between a first wall stud 114 and a second wall stud 116. The brace 102 includes a first stud plate 118 secured to the first wall stud 114 and a second stud plate 120 secured to the second wall stud 116. An upper outer arm 122 and lower outer arm 124 extend from the first stud plate 118 and an upper inner arm 126 and a lower inner arm 128 extend from the second stud plate 120. The outer arms 122, 124 and inner arms 126, 128 are slidably moveably relative to one another in a telescopic fashion so that the width of the mounting brace 102 can be adjusted for different stud spacing as needed. A plurality of aligning apertures 130 are provided in the outer arms 122, 124 and inner arms 126, 18 configured to receive a mechanical fastener. Various fasteners can be used to secure the position of the outer arms 122, 124 and inner arms 126, 18 relative to each other and to secure electrical devices to the brace 102.

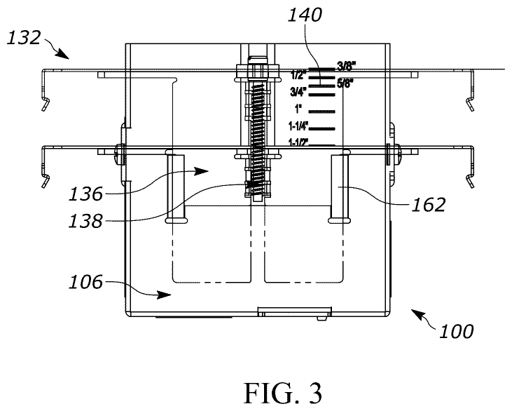

As best shown in FIGS. 1-3, the end walls 106 are connected to an adjustable mounting bracket 132 which is releasably secured to the mounting brace 102. The adjustable mounting bracket 132 includes a mounting plate 134, an adjustment plate 136, and a jackscrew 138. Rotation of the jackscrew 138 can adjust the position of the mounting plate 134 and adjustments plate 136 relative to the end wall 106 as shown in FIG. 3. For example, turning the jackscrew 138 can adjust the position of the mounting plate 134 relative to the open front of the electrical box 100, which also moves the front of the electrical box 100 relative to the mounting brace 102. Depth adjustments between 0.375 and 1.5 inches can be achieved. Indicators 140 can be provided on the end wall 106 to help a user set a desired position on each mounting bracket 132.

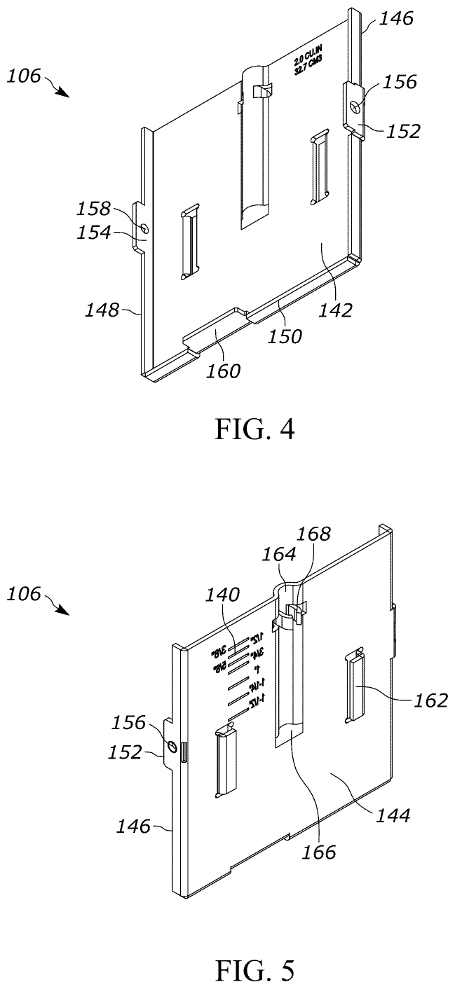

FIGS. 4 and 5 show an exemplary configuration of the end wall 106 having an interior side 142 facing the interior of the electrical box 100 and an exterior side 144 facing away from the interior of the electrical box 100. The size and shape of the end wall 106 can be adjusted according to the configuration of the corresponding electrical box.

The interior side 142 of the end wall can include an upper flange 146, a lower flange 148, and a rear flange 150 extending in the direction of the interior side. An upper tab 152 extends from the upper flange 146 and a lower tab 154 extends from the lower flange 148. A fastener aperture 156, 158 extends through the upper and lower tabs 152, 154. A fastener can extend through a respective fastener aperture 156, 158 to connect the end wall 106 to a side wall 104 of an electrical box 100. A rear tab 160 extends from the rear flange 150. The rear tab 160 can engage a rear side wall 104 of the electrical box 104 to act as a stop.

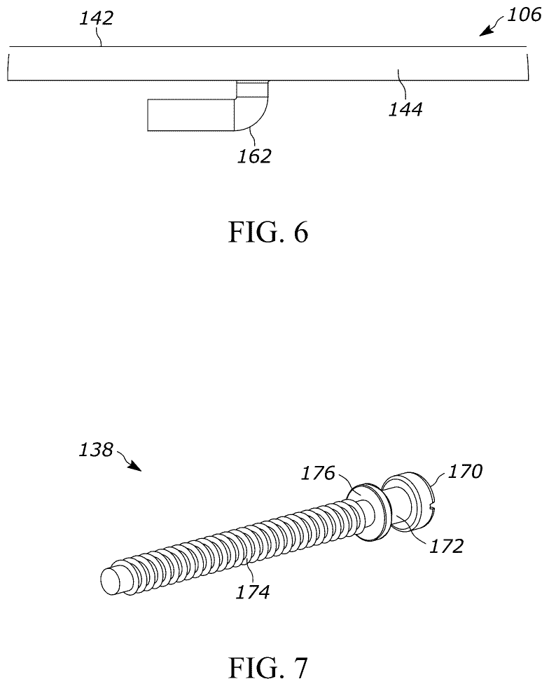

The exterior side 144 of the end wall 106 can include a pair of opposing bracket tabs 162. As best shown in FIG. 6, the bracket tabs 162 have a first portion that extends from an exterior surface of the end wall 106 and a second portion that extends from the first portion. The second portion of the bracket tabs 162 extend toward one another so that a slot is formed between the second portions of the bracket tabs 162 and an exterior surface of the end wall 106. This slot is configured to slidably receive the adjustment plate 136 of the mounting bracket 132.

As further shown in FIG. 5, the exterior side 144 of the end wall 106 can include a groove 164 configured to receive the jackscrew 138. The groove 164 has a proximal portion with an open end and a distal portion bounded by a closed wall 166. A pair of opposing tines 168 are positioned in the proximal portion of the groove 164. The tines 168 can be bent around the jackscrew 138 to rotatably secure the jackscrew 138 to the end wall 106.

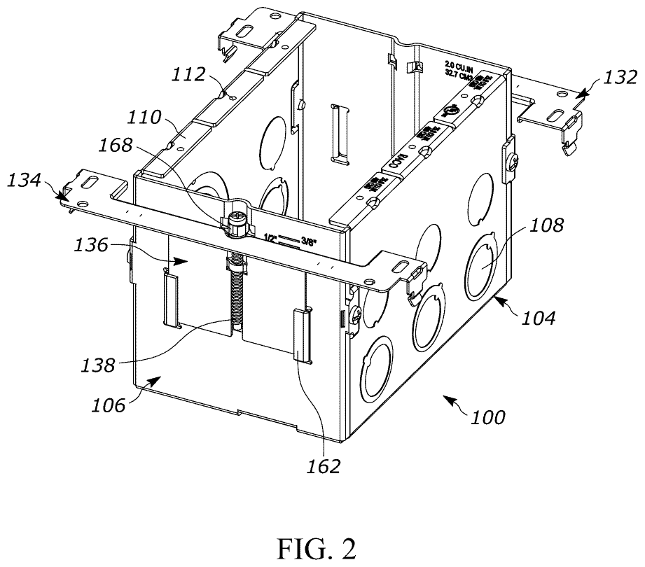

As best shown in FIG. 7, the jackscrew can include a head 170 and a shank 172 having a threaded portion 174. A flange 176 extends around the shank 172 above the threads 174 below the head 170. The portion of the shank 172 between the head 170 and the flange 176 acts as a bearing surface that is received between the tines 168 of the end wall 106. Through this connection, as best shown in FIGS. 2 and 3, translation of the jackscrew 138 is resisted while rotation is permitted.

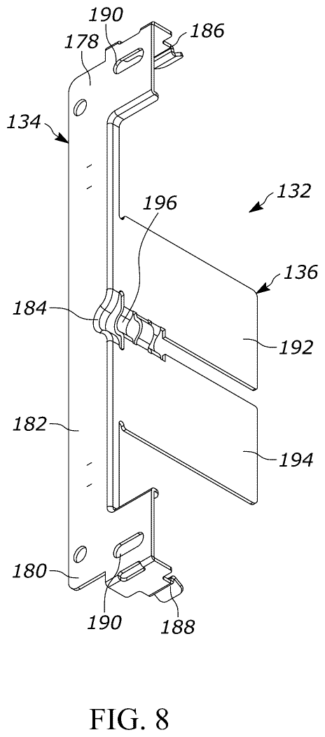

FIG. 8 shows an exemplary configuration of the mounting bracket 132. In certain configuration the mounting plate 134 and the adjustment plate 136 are unitarily formed of a single body. Other configurations can utilize separate pieces that are fastened together, for example through mechanical fasteners or welding.

The mounting plate 134 includes an upper portion 178, a lower portion 180, and a side portion 182 extending between the upper portion 178 and lower portion 180. A curved recess 184 can be formed in the side portion 182 to receive the jackscrew 138. An upper clip 186 extends from the upper portion 178 and a lower clip 188 extends from the lower portion 180. The upper and lower clips 186, 188 are configured to releasably engage the upper arms 122, 126 and lower arms 124, 128 respectively. Slots 190 can be provided in the upper portion 178 and lower portion 180 to receive a fastener to secure the mounting bracket 132 to the upper arms 122, 126 and lower arms 124, 128 of the brace 102. The clips 186, 188 can be used to position the mounting brackets 132 on the brace 102, and then the position of the electrical box 100 can be adjusted relative to the brace 102 without the need for a user to hold the mounting bracket 132 and the attached electrical box 100 in place. Fasteners can then be inserted into the slots 190 and through the apertures 130 in the mounting brace 102 arms to secure the mounting bracket 132 and electrical box 100 in place without having to hold these components by hand.

The adjustment plate 136 extends from the mounting plate 134. In certain configurations, the adjustment plate 136 is oriented substantially perpendicular to the mounting plate 134. The adjustment plate 136 includes an upper body 192 and a lower body 194 separated by a slot. One or more bridges 196 extend between the upper body 192 and the lower body 194. In the illustrated embodiment, three curved bridges are used. The bridges 196 include a front concave bridge, a middle convex bridge, and a rear concave bridge relative to the interior side of the adjustment plate. The alternating curved bridges 196 form a passage for receiving the jackscrew 138. The threads 174 of the jackscrew 138 can engage the bridges 196, so that rotation of the jackscrew 138 causes translation of the adjustment plate 136 and mounting plate 134 relative to the end wall 106.

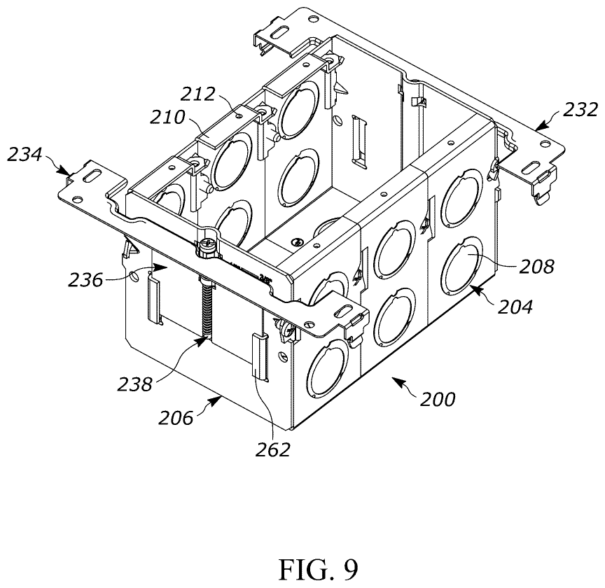

FIG. 9 shows another configuration of an electrical box 200, which can be used, for example, in masonry application. The electrical box 200 includes side walls 204 (top, bottom, and rear) and removable end walls 206. Although a three-gang box 200 is shown, the box 200 is gangable and in certain configurations can be connected to other one, two, or three gang boxes to expand the number of available connections provided in a single box. Other implementations can utilize any combination of one, two, or three gang housing side wall configurations to create any size electrical box.

The side walls 204 include a plurality of knockouts 208 positioned to provide electrical connections to the box 200. The knockouts 208 can include concentric and non-concentric circles to provide an opening as large as four inches as needed. The knockouts 208 can be removed as needed to provide communication with exterior cabling or conduits that are run to the box 200.

The upper and lower side wall 204 can include inwardly extending flanges 210 for supporting an electrical wiring device, for example a switch. Each flange 210 includes a threaded aperture 212 for receiving a mounting screw.

The end walls 206 are connected to an adjustable mounting bracket 232. The adjustable mounting bracket 232 includes a mounting plate 234, an adjustment plate 236, and a jackscrew 238. Rotation of the jackscrew 238 can adjust the position of the mounting plate 234 and adjustments plate 236 relative to the end wall 206. Depth adjustments between 0.375 and 1.5 inches can be achieved. Indicators 240 can be provided on the end wall 206 to help a user set a desired position on each mounting bracket 232.

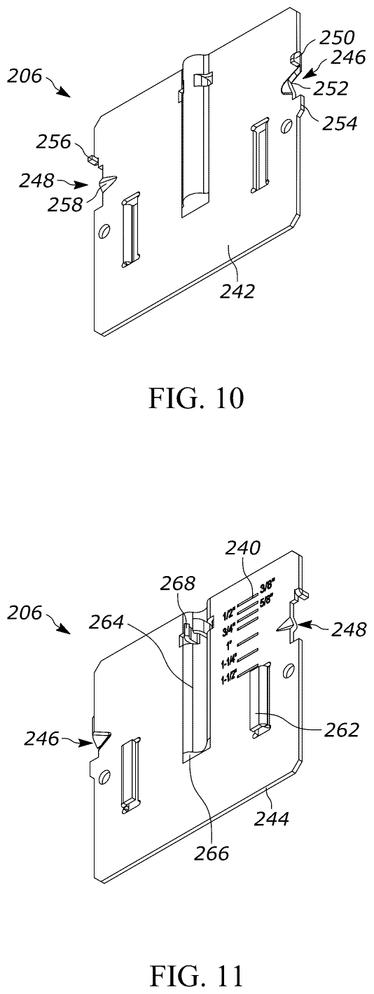

FIGS. 10 and 11 show an exemplary configuration of the end wall 206 having an interior side 242 facing the interior of the electrical box 200 and an exterior side 244 facing away from the interior of the electrical box 200. The size and shape of the end wall 106 can be adjusted according to the configuration of the corresponding electrical box.

The outer edge of the end wall 206 can include a first connecting feature 246 on a first side and a second connecting feature 248 on an opposing side. The connecting features 246, 248 are configured to connect to the upper and lower side walls 204.

In an exemplary configurations, the first connecting feature can include a first tab 250 extending inwardly relative to the end wall 206, a slot with an angled protrusion 252, and a second tab 254 that extends outwardly relative to the outer edge of the end wall 206. The second connecting feature can include a first tab 256 and a slot with an angled protrusion 258.

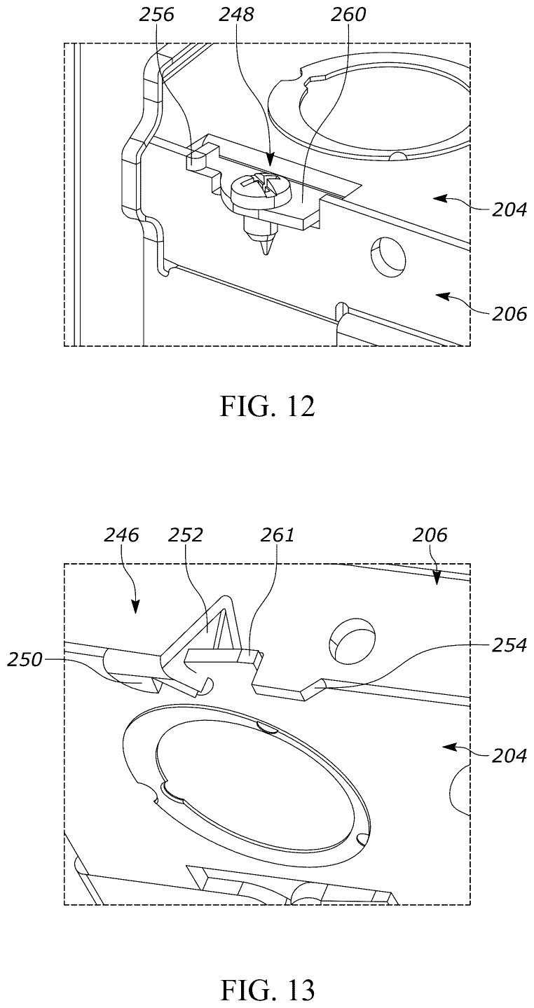

As best shown in FIGS. 12 and 13, the first connecting feature 246 and the second connecting feature 248 interlock with corresponding features on the side walls 204. The first connecting feature 246 is configured to receive a first projection 260 and a fastener and the second connecting feature 248 is configured to receive a second projection 261. These interlocking features provide a secure connection for the side walls 204 and end walls 206.

As shown in FIG. 11, the exterior side 244 of the end wall 206 can include a pair of opposing bracket tabs 262. The bracket tabs 262 have a first portion that extends from an exterior surface of the end wall 206 and a second portion that extends from the first portion. The second portion of the bracket tabs 262 extend toward one another so that a slot is formed between the second portions of the bracket tabs 262 and an exterior surface of the end wall 206. This slot is configured to slidably receive the adjustment plate 236 of the mounting bracket 232.

The exterior side 244 of the end wall 206 can include a groove 264 configured to receive the jackscrew 238. The groove 264 has a proximal portion with an open end and a distal portion bounded by a closed wall 266. A pair of opposing tines 268 are positioned in the proximal portion of the groove 264. The tines 268 can be bent around the jackscrew 238 to rotatably secure the jackscrew 238 to the end wall 206.

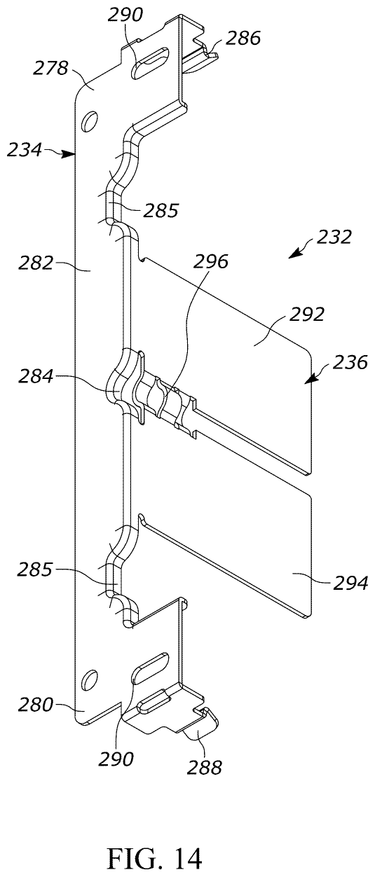

FIG. 14 shows an exemplary configuration of the mounting bracket 232. In certain configuration the mounting plate 234 and the adjustment plate 236 are unitarily formed of a single body. Other configurations can utilize separate pieces that are fastened together, for example through mechanical fasteners or welding.

The mounting plate 234 includes an upper portion 278, a lower portion 280, and a side portion 282 extending between the upper portion 278 and lower portion 280. A central curved recess 284 can be formed in the side portion 282 to receive the jackscrew 238. Outer curved recesses 285 can be formed in the side portion to provide clearance for the connecting features 246, 248. An upper clip 286 extends from the upper portion 278 and a lower clip 288 extends from the lower portion 280. The upper and lower clips 286, 288 are configured to releasably engage the upper arms 122, 126 and lower arms 124, 128 respectively of the mounting brace 102. Slots 290 can be provided in the upper portion 278 and lower portion 280 to receive a fastener to secure the mounting bracket 232 to the upper arms 122, 126 and lower arms 124, 128 of the brace 102. The clips 286, 288 can be used to position the mounting brackets 232 on the brace 102, and then the position of the electrical box 200 can be adjusted relative to the brace 102 without the need for a user to hold the mounting bracket 232 and the attached electrical box 200 in place. Fasteners can then be inserted into the slots 290 and through the apertures 130 in the mounting brace 102 arms to secure the mounting bracket 232 and electrical box 100 in place without having to hold these components by hand.

The adjustment plate 236 extends from the mounting plate 234. In certain configurations, the adjustment plate 236 is oriented substantially perpendicular to the mounting plate 234. The adjustment plate 236 includes an upper body 292 and a lower body 294 separated by a slot. One or more bridges 296 extend between the upper body 292 and the lower body 294. In the illustrated embodiment, three curved bridges are used. The bridges 296 include a front concave bridge, a middle convex bridge, and a rear concave bridge relative to the interior side of the adjustment plate 236. The alternating curved bridges 296 form a passage for receiving the jackscrew 238. The threads of the jackscrew 238 can engage the bridges 296, so that rotation of the jackscrew 238 causes translation of the adjustment plate 236 and mounting plate 234 relative to the end wall 206.

The foregoing detailed description of the certain exemplary configurations and implementations has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

What is claimed:

1. An electrical box assembly comprising:
a plurality of side walls, at least one of the plurality of side walls having a knockout configured to be removed to receive an electrical conductor;
an end wall releasably connected to the plurality of side walls, the end wall having a groove;
a mounting bracket connected to the end wall, the mounting bracket include a mounting plate, an adjustment plate, and a threaded adjustment member received in the groove, wherein rotation of the adjustment member causes the mounting bracket to translate relative to the end wall.

2. The electrical box assembly of claim 1, wherein the end wall includes a first bracket tab and a second bracket tab, the first and second bracket tabs at least partially defining a slot for slidably receiving at least a portion of the mounting bracket.

3. The electrical box assembly of claim 2, wherein the first and second bracket tabs slidably receive the adjustment plate.

4. The electrical box assembly of claim 1, wherein the end wall includes a pair of opposing tines configured to receive the threaded adjustment member.

5. The electrical box assembly of claim 1, wherein the threaded adjustment member includes a head and a shank, the shank having a threaded portion and a flange extending between the threaded portion and the head.

6. The electrical box assembly of claim 1, wherein the mounting plate includes a resilient clip configured to connect to a brace.

7. The electrical box assembly of claim 1, wherein the adjustment plate includes an upper body, a lower body separated from the upper body by a slot, and a bridge extending between the upper body and lower body.

8. The electrical box assembly of claim 7, wherein the bridge is curved and configured to engage the threaded adjustment member.

9. The electrical box assembly of claim 1, wherein the mounting bracket is configured to provide and adjustable depth for the end wall and side walls between 0.375 and 1.5 inches (between 9.5 and 38.1 mm).

10. The electrical box assembly of claim 1, wherein the end wall includes an upper flange, an upper tab extending from the upper flange, a lower flange, and a lower tab extending from the lower flange.

11. An electrical box assembly comprising:
a plurality of first side walls, at least one of the first side walls having a knockout configured to be removed to receive an electrical conductor;
a plurality of second side walls positioned opposite the first side walls to define an interior for receiving an electrical device;
an end wall releasably connected to at least one of the first side walls and one of the second side walls, the end wall having a groove;
a mounting bracket connected to the end wall, the mounting bracket include a mounting plate, an adjustment plate, and a threaded adjustment member received in the groove, wherein rotation of the adjustment member causes the mounting bracket to translate relative to the end wall.

12. The electrical box assembly of claim 11, wherein the end wall includes a first bracket tab and a second bracket tab, the first and second bracket tabs at least partially defining a slot for slidably receiving at least a portion of the mounting bracket.

13. The electrical box assembly of claim 12, wherein the first and second bracket tabs slidably receive the adjustment plate.

14. The electrical box assembly of claim 11, wherein the mounting plate includes a resilient clip configured to connect to a brace.

15. The electrical box assembly of claim 11, wherein the adjustment plate includes an upper body, a lower body separated from the upper body by a slot, and a bridge extending between the upper body and lower body.

16. An electrical box assembly comprising:
a plurality of first side walls, at least one of the first side walls having a knockout configured to be removed to receive an electrical conductor;
a plurality of second side walls positioned opposite the first side walls to define an interior for receiving an electrical device;
an end wall releasably connected to at least one of the first side walls and one of the second side walls, the end wall having a groove, a first connecting feature for securing the end wall to the at least one first side wall, and a second connecting feature for securing the end wall to the at least one second side wall;
a mounting bracket connected to the end wall, the mounting bracket include a mounting plate, an adjustment plate, and a threaded adjustment member received in the groove, wherein rotation of the adjustment member causes the mounting bracket to translate relative to the end wall.

17. The electrical box assembly of claim 16, wherein first connecting feature is configured to receive a first projection and a fastener and the second connecting feature is configured to receive a second projection.

18. The electrical box assembly of claim 16, wherein first connecting feature includes a first tab extending inwardly relative to the end wall, a first slot with an angled protrusion, and a second tab that extends outwardly relative to the outer edge of the end wall and the second connecting feature includes a third tab and a second slot with an angled protrusion.

19. The electrical box assembly of claim 16, wherein the end wall includes an upper flange, an upper tab extending from the upper flange, a lower flange, and a lower tab extending from the lower flange.

20. The electrical box assembly of claim 16, wherein the adjustment plate includes an upper body, a lower body separated from the upper body by a slot, and a bridge extending between the upper body and lower body.
